(19) United States
(12) Patent Application Publication
(10) Pub. No.: US 2026/0085155 A1
(43) Pub. Date: Mar. 26, 2026

(54) ORGANOPOLYSILOXANE COMPOUND AND PRODUCTION METHOD THEREOF

(71) Applicant: JNC CORPORATION, Tokyo (JP)

(72) Inventors: Nobuo ENOKI, Chiba (JP); Takuro TANAKA, Chiba (JP)

(73) Assignee: JNC CORPORATION, Tokyo (JP)

(21) Appl. No.: 19/262,142

(22) Filed: Jul. 8, 2025

(30) Foreign Application Priority Data
Sep. 26, 2024 (JP) 2024-166911

(51) Int. Cl. C08G 77/14

(52) U.S. Cl. CPC C08G 77/14

(57) ABSTRACT

An organopolysiloxane compound is represented by formula (1) and has a molecular weight distribution (Mw/Mn) of 2.0 or less. In formula (1), R¹ to R⁴ each represent a specific group, n is an integer of 3 or greater, and p is 3 or 4.

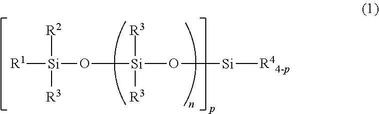

### CROSS-REFERENCE TO RELATED APPLICATION

This application claims the priority benefit of Japan application serial no. 2024-166911, filed on Sep. 26, 2024. The entirety of the above-mentioned patent application is hereby incorporated by reference herein and made a part of this specification.

### BACKGROUND

### Technical Field

The disclosure relates to an organopolysiloxane compound characterized by having a narrow molecular weight distribution, and a production method thereof.

### Related Art

Organopolysiloxane compounds are useful as a raw material of silicone rubber compositions widely used in building materials, daily necessities, medical equipment, electronic materials or the like. Moreover, by using organopolysiloxane compounds as an additive to organic resins, characteristics such as excellent flexibility, water repellency, releasability, weather resistance, heat resistance, and electrical insulation properties due to the structure of the organopolysiloxane compounds can be imparted to the organic resins. Hence, organopolysiloxane compounds have high utility value.

In general, besides linear organopolysiloxanes, branched organopolysiloxanes having branches are known as organopolysiloxane compounds. For example, Japanese Patent Laid-open No. H10-316945 discloses a branched organopolysiloxane for the purpose of manufacturing an adhesive sheet exhibiting light peelability and little change in peeling strength over time for solvent-free release agents, and Japanese Unexamined Patent Application Publication (Translation of PCT Application) No. 2020-523422 discloses a branched organopolysiloxane for the purpose of improving processability, peeling strength, and flatness of solvent-free pressure-sensitive adhesives.

However, the molecular weight distribution of these branched organopolysiloxanes has not been discussed. In general, as the molecular weight distribution is widened, low molecular weight components tend to be increased. In the case where such an organopolysiloxane having a large number of low molecular weight components is used as a product, the low molecular weight components volatilize as outgas, causing various defects such as bubble formation or heating furnace contamination.

On the other hand, Japanese Patent Laid-open No. 2018-31016 discloses a linear organopolysiloxane compound and a production method thereof, in which by using a living anionic ring-opening polymerization method, the linear organopolysiloxane compound is expected to be reduced in viscosity and improved in low-temperature curing properties and various mechanical properties, have a narrow molecular weight distribution and have one unsaturated group terminal and one hydride terminal.

However, in Japanese Patent Laid-open No. 2018-31016, there is neither discussion about branched organopolysiloxanes nor evaluation of remaining low molecular weight components.

A branched organopolysiloxane synthesized by a conventional method has a wide molecular weight distribution and may contain a large number of low molecular weight components, thus making it difficult to reduce outgas generation. From the viewpoint of preventing defects such as bubble formation or heating furnace contamination, there remains room for improvement. According to the disclosure, a branched organopolysiloxane compound and a production method thereof are provided, in which the branched organopolysiloxane compound suppresses outgas generation and has a narrow molecular weight distribution.

### SUMMARY

An organopolysiloxane compound is represented by formula (1) and has a molecular weight distribution (Mw/Mn) of 2.0 or less.

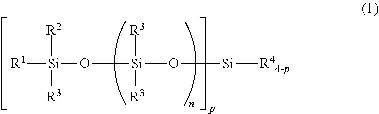

In formula (1), R¹ is hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, aryl in which at least one hydrogen atom may be replaced with a halogen atom, a functional group, or a group having a functional group; R² is alkyl or aryl; R³ is each independently hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, or aryl in which at least one hydrogen atom may be replaced with a halogen atom; R⁴ is hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, aryl in which at least one hydrogen atom may be replaced with a halogen atom, a functional group, or a group having a functional group; n is an integer of 3 or greater; and p is 3 or 4.

### DESCRIPTION OF THE EMBODIMENTS

As a result of intensive studies conducted by the present inventors, it has been found that a branched organopolysiloxane compound having a narrow molecular weight distribution can be produced by processes of: reacting an organometallic compound with a cyclic siloxane to generate a metal silanolate; followed by reacting with cyclotrisiloxane or cyclotetrasiloxane; stopping polymerization by adding water or acid as needed; and reacting with trichlorosilane, tetrachlorosilane, trialkoxysilane or tetraalkoxysilane. It has also been found that the branched organopolysiloxane compound having a controlled narrow molecular weight distribution, which is obtained by the aforementioned production method, suppresses outgas generation. Thus, the disclosure is completed.

The disclosure includes the following configurations.
[1] An organopolysiloxane compound, represented by formula (1) and having a molecular weight distribution (Mw/Mn) of 2.0 or less.

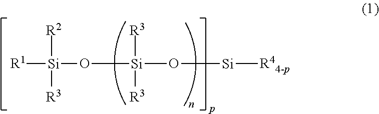

In formula (1), R¹ is hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, aryl in which at least one hydrogen atom may be replaced with a halogen atom, a functional group, or a group having a functional group;
R² is alkyl or aryl;
R³ is each independently hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, or aryl in which at least one hydrogen atom may be replaced with a halogen atom;
R⁴ is hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, aryl in which at least one hydrogen atom may be replaced with a halogen atom, a functional group, or a group having a functional group;
n is an integer of 3 or greater; and
p is 3 or 4.
[2] The organopolysiloxane compound as described in [1], in which in formula (1), R¹ is hydrogen, or alkenyl having 2 to 6 carbon atoms; R² is alkyl having 1 to 4 carbon atoms or phenyl; R³ is each independently hydrogen, methyl, vinyl, 3,3,3-trifluoropropyl, or phenyl.
[3] The organopolysiloxane compound as described in [1] or [2], in which in formula (1), R¹ is hydrogen or vinyl; R² is alkyl having 1 to 4 carbon atoms or phenyl; R³ is each independently hydrogen, methyl, vinyl, 3,3,3-trifluoropropyl, or phenyl.
[4] The organopolysiloxane compound as described in any one of [1] to [3], in which in formula (1), R¹ is hydrogen or vinyl; R² is butyl; R³ is methyl; R⁴ is hydrogen or methyl.
[5]A production method of the organopolysiloxane compound as described in any one of [1] to [4], including processes of: reacting an organometallic compound with a cyclic siloxane to generate a metal silanolate; followed by reacting the metal silanolate with cyclotrisiloxane or cyclotetrasiloxane, thereby generating a compound represented by formula (2); and further followed by reacting the compound represented by formula (2) with a compound represented by formula (3).

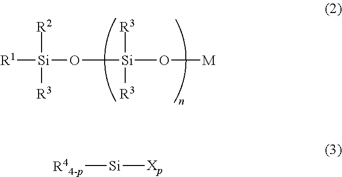

In formula (2), R¹ is hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, aryl in which at least one hydrogen atom may be replaced with a halogen atom, a functional group, or a group having a functional group;
R² is alkyl or aryl;
R³ is each independently hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, or aryl in which at least one hydrogen atom may be replaced with a halogen atom;
M is a monovalent metal; and
n is an integer of 3 or greater.

In formula (3), R⁴ is hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, aryl in which at least one hydrogen atom may be replaced with a halogen atom, a functional group, or a group having a functional group;
X is halogen or alkoxy; and
p is 3 or 4.
[6] The production method of the organopolysiloxane compound as described in [5], in which the organometallic compound is an alkyllithium compound, the cyclic siloxane is a compound represented by formula (4), and the metal silanolate is a lithium silanolate.

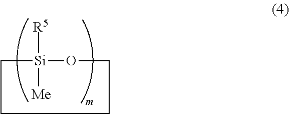

(The symbol “Me” above represents methyl.)

In formula (4), R⁵ is hydrogen or vinyl, and m is 3 or 4.
[7]A production method of the organopolysiloxane compound as described in any one of [1] to [4], including processes of: reacting an organometallic compound with a cyclic siloxane to generate a metal silanolate; followed by reacting the metal silanolate with cyclotrisiloxane or cyclotetrasiloxane, thereby generating a compound represented by formula (2); followed by stopping polymerization by adding water or acid to the compound represented by formula (2), thereby generating a compound represented by formula (2′); and further followed by reacting the compound represented by formula (2′) with a compound represented by formula (3).

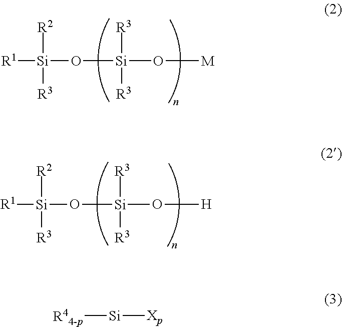

In formula (2), R¹ is hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, aryl in which at least one hydrogen atom may be replaced with a halogen atom, a functional group, or a group having a functional group;
R² is alkyl or aryl;
R³ is each independently hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, or aryl in which at least one hydrogen atom may be replaced with a halogen atom;
M is a monovalent metal; and
n is an integer of 3 or greater.

In formula (2′), R¹, R², and R³ are groups having the same definitions as R¹, R², and R³ in formula (2); and n has the same definition as n in formula (2).

In formula (3), R⁴ is hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, aryl in which at least one hydrogen atom may be replaced with a halogen atom, a functional group, or a group having a functional group;
X is halogen or alkoxy; and
p is 3 or 4.
[8] The production method of the organopolysiloxane compound as described in [7], in which the organometallic compound is an alkyllithium compound, the cyclic siloxane is the compound represented by formula (4) as described in [6], and the metal silanolate is a lithium silanolate.

According to the disclosure, a branched organopolysiloxane compound can be obtained which can suppress outgas generation by having a narrow molecular weight distribution by living anionic ring-opening polymerization.

An embodiment of the disclosure will be described in detail below. However, the following description is only an example (representative example) of embodiments of the disclosure, and the disclosure is not limited to these contents in any way. The embodiments of the disclosure can also be appropriately combined. In the present specification, the symbol “Me” means methyl, and the symbol “ⁿBu” means normal butyl.

### <Organopolysiloxane Compound>

An organopolysiloxane compound of the disclosure is characterized by being represented by formula (1), having a molecular weight distribution (Mw/Mn) of 2.0 or less, and being branched.

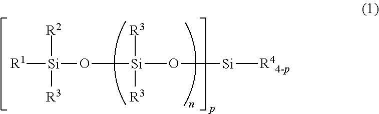

In formula (1), R¹ is hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, aryl in which at least one hydrogen atom may be replaced with a halogen atom, a functional group or a group having a functional group; at least one —CH₂— contained in R¹ may be replaced with alkenylene, alkynylene, cycloalkylene, cycloalkenylene, phenylene, ether, carbonyl, ester, amide, imide, urethane, urea, sulfide, disulfide, sulfonyl, 1-oxo-2-oxapropane-1,3-diyl, 2-oxapropane-1,3-dioyl (1,3-dioxo-2-oxapropane-1,3-diyl), or polyalkylene oxy.

Specific examples of alkyl in which at least one hydrogen atom may be replaced with a halogen atom include methyl, ethyl, propyl, butyl, pentyl, hexyl, heptyl, octyl, nonyl, decyl, undecyl, dodecyl, tetradecyl, hexadecyl, octadecyl, icosyl, docosyl, or triacontyl.

Specific examples of alkenyl in which at least one hydrogen atom may be replaced with a halogen atom include vinyl, propenyl, butenyl, pentenyl, hexenyl, heptenyl, octenyl, nonenyl, decenyl, undecenyl, dodecenyl, tetradecenyl, hexadecenyl, octadecenyl, icosenyl, or docosenyl.

Specific examples of alkynyl in which at least one hydrogen atom may be replaced with a halogen atom include acetylenyl, propynyl, butynyl, or hexynyl.

Specific examples of cycloalkyl in which at least one hydrogen atom may be replaced with a halogen atom include cyclopropyl, cyclobutyl, cyclopentyl, cyclohexyl, cycloheptyl, cyclooctyl, bornyl, isobornyl, norbornyl, norbornenyl, norbornadienyl, cyclopentadienyl, dicyclopentadienyl, dihydrodicyclopentadienyl, tetrahydrodicyclopentadienyl, decalyl, or adamantyl.

Specific examples of aryl in which at least one hydrogen atom may be replaced with a halogen atom include phenyl, tolyl, benzyl, phenylethyl, naphthyl, vinylphenyl, styryl, metastyryl, phenylpropyl, or vinylphenylethyl.

Specific examples of functional group include hydroxy, amino, nitro, mercapto, phosphino, cyano, isocyanato, alkoxy, carboxy, sulfone, oxiranyl, oxetanyl, epoxycyclohexyl, acryloyl, or methacryloyl.

A group having a functional group is a group composed of a divalent group and a functional group that is bonded to a Si atom through the divalent group. Specific examples of the divalent group include alkylene, cycloalkylene, alkylcycloalkylene, alkylenephenylene, alkylphenylene, or alkylphenylalkylene, or the like, and the functional group is bonded to the Si atom through these divalent groups. Specific examples of the functional group bonded through the divalent group include hydroxy, amino, nitro, mercapto, phosphino, cyano, isocyanato, alkoxy, carboxy, sulfone, oxiranyl, oxetanyl, epoxycyclohexyl, or (meth)acryloyl.

From the viewpoint of introducing a reactive group to a polysiloxane chain end and raw material availability, R¹ is preferably hydrogen, or alkenyl having 2 to 6 carbon atoms, and more preferably hydrogen or vinyl.

In formula (1), R² is alkyl or aryl.

Specific examples of alkyl include methyl, ethyl, propyl, butyl, pentyl, hexyl, heptyl, octyl, nonyl, decyl, undecyl, dodecyl, tetradecyl, hexadecyl, octadecyl, icosyl, docosyl, or triacontyl.

Specific examples of aryl include phenyl, tolyl, benzyl, phenylethyl, naphthyl, vinylphenyl, (meta)styryl, phenylpropyl, or vinylphenylethyl.

R² is preferably alkyl having 1 to 4 carbon atoms or phenyl from the viewpoint of raw material availability, and is more preferably butyl from the viewpoint of handleability.

In formula (1), R³ is each independently hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, or aryl in which at least one hydrogen atom may be replaced with a halogen atom; at least one —CH₂— contained in R³ may be replaced with alkenylene, alkynylene, cycloalkylene, cycloalkenylene, phenylene, ether, carbonyl, ester, amide, imide, urethane, urea, sulfide, disulfide, sulfonyl, 1-oxo-2-oxapropane-1,3-diyl, 2-oxapropane-1,3-dioyl (1,3-dioxo-2-oxapropane-1,3-diyl), or polyalkylene oxy.

Specific examples of alkyl in which at least one hydrogen atom may be replaced with a halogen atom include methyl, ethyl, propyl, butyl, pentyl, hexyl, heptyl, octyl, nonyl, decyl, undecyl, dodecyl, tetradecyl, hexadecyl, octadecyl, icosyl, docosyl, or triacontyl.

Specific examples of alkenyl in which at least one hydrogen atom may be replaced with a halogen atom include vinyl, propenyl, butenyl, pentenyl, hexenyl, heptenyl, octenyl, nonenyl, decenyl, undecenyl, dodecenyl, tetradecenyl, hexadecenyl, octadecenyl, icosenyl, or docosenyl.

Specific examples of alkynyl in which at least one hydrogen atom may be replaced with a halogen atom include acetylenyl, propynyl, butynyl, or hexynyl.

Specific examples of cycloalkyl in which at least one hydrogen atom may be replaced with a halogen atom include cyclopropyl, cyclobutyl, cyclopentyl, cyclohexyl, cycloheptyl, cyclooctyl, bornyl, isobornyl, norbornyl, norbornenyl, norbornadienyl, cyclopentadienyl, tetrahydrodicyclopentadienyl, dihydrodicyclopentadienyl, dicyclopentadienyl, decalyl, or adamantyl.

Specific examples of aryl in which at least one hydrogen atom may be replaced with a halogen atom include phenyl, tolyl, benzyl, phenylethyl, naphthyl, vinylphenyl, (meta)styryl, phenylpropyl, or vinylphenylethyl.

R³ is preferably hydrogen, methyl, vinyl, 3,3,3-trifluoropropyl, or phenyl from the viewpoint of raw material availability, and more preferably methyl from the viewpoint of polymerizability.

In formula (1), R⁴ is hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, aryl in which at least one hydrogen atom may be replaced with a halogen atom, a functional group or a group having a functional group; at least one —CH₂— contained in R⁴ may be replaced with alkenylene, alkynylene, cycloalkylene, cycloalkenylene, phenylene, ether, carbonyl, ester, amide, imide, urethane, urea, sulfide, disulfide, sulfonyl, 1-oxo-2-oxapropane-1,3-diyl, 2-oxapropane-1,3-dioyl (1,3-dioxo-2-oxapropane-1,3-diyl), or polyalkylene oxy.

Specific examples of alkyl in which at least one hydrogen atom may be replaced with a halogen atom include methyl, ethyl, propyl, butyl, pentyl, hexyl, heptyl, octyl, nonyl, decyl, undecyl, dodecyl, tetradecyl, hexadecyl, octadecyl, icosyl, docosyl, or triacontyl.

Specific examples of alkenyl in which at least one hydrogen atom may be replaced with a halogen atom include vinyl, propenyl, butenyl, pentenyl, hexenyl, heptenyl, octenyl, nonenyl, decenyl, undecenyl, dodecenyl, tetradecenyl, hexadecenyl, octadecenyl, icosenyl, or docosenyl.

Specific examples of alkynyl in which at least one hydrogen atom may be replaced with a halogen atom include acetylenyl, propynyl, butynyl, or hexynyl.

Specific examples of cycloalkyl in which at least one hydrogen atom may be replaced with a halogen atom include cyclopropyl, cyclobutyl, cyclopentyl, cyclohexyl, cycloheptyl, cyclooctyl, bornyl, isobornyl, norbornyl, norbornenyl, norbornadienyl, cyclopentadienyl, dicyclopentadienyl, dihydrodicyclopentadienyl, tetrahydrodicyclopentadienyl, decalyl, or adamantyl.

Specific examples of aryl in which at least one hydrogen atom may be replaced with a halogen atom include phenyl, tolyl, benzyl, phenylethyl, naphthyl, vinylphenyl, (meta)styryl, phenylpropyl, or vinylphenylethyl.

Specific examples of functional group include hydroxy, amino, nitro, mercapto, phosphino, cyano, isocyanato, alkoxy, carboxy, sulfone, oxyranyl, oxetanyl, epoxycyclohexyl, or (meth)acryloyl.

A group having a functional group is a group composed of a divalent group and a functional group that is bonded to a Si atom through the divalent group. Specific examples of the divalent group include alkylene, cycloalkylene, alkylcycloalkylene, alkylenephenylene, alkylphenylene, or alkylphenylalkylene, or the like, and the functional group is bonded to the Si atom through these divalent groups. Specific examples of the functional group bonded through the divalent group include hydroxy, amino, nitro, mercapto, phosphino, cyano, isocyanato, alkoxy, carboxy, sulfone, oxiranyl, oxetanyl, epoxycyclohexyl, or (meth)acryloyl.

From the viewpoint of reliably introducing an organopolysiloxane chain to obtain a branched organopolysiloxane compound, R⁴ is preferably hydrogen or methyl.

From the viewpoint of reliably introducing an organopolysiloxane chain to obtain a branched organopolysiloxane compound, in formula (1), n is preferably an integer of 3 to 300, and more preferably an integer of 6 to 200.

In formula (1), p is an integer of 3 or 4.

An organopolysiloxane compound obtained by a production method of the disclosure has a narrow molecular weight distribution, thereby reducing low molecular weight components. Thus, it is possible to reduce outgas during heating. The molecular weight distribution (Mw/Mn) of the organopolysiloxane compound obtained by the production method of the disclosure is 2.0 or less, and more preferably 1.5 or less.

### <Production Method of Organopolysiloxane Compound>

The production method of the organopolysiloxane compound of the disclosure includes processes of: reacting an organometallic compound with a cyclic siloxane to generate a metal silanolate; followed by reacting the metal silanolate with cyclotrisiloxane or cyclotetrasiloxane, thereby generating a compound represented by formula (2); stopping polymerization by adding water or acid to the compound represented by formula (2) as needed, thereby generating a compound represented by formula (2′); and further followed by reacting the compound represented by formula (2) or (2′) with a compound represented by formula (3).

In the case of stopping polymerization by adding water or acid to the compound represented by formula (2), the polymerization is stopped by neutralizing a growth terminal with water or acid.

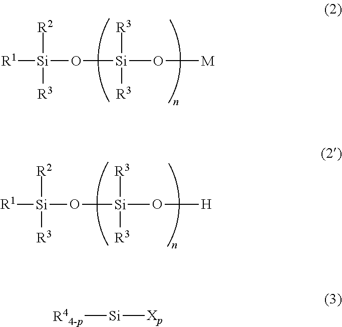

Specific examples of the organometallic compound include methyllithium, ethyllithium, propyllithium, butyllithium, phenyllithium, or phenylsodium. Among them, methyllithium, n-butyllithium, s-butyllithium, t-butyllithium, or phenyllithium are preferable, and n-butyllithium is particularly preferable.

Specific examples of the cyclic siloxane include trimethylcyclotrisiloxane, hexamethylcyclotrisiloxane, hexaethylcyclotrisiloxane, pentamethylvinylcyclotrisiloxane, trimethyltrivinylcyclotrisiloxane, trimethyltriphenylcyclotrisiloxane, hexaphenylcyclotrisiloxane, tris(trifluoropropyl)trimethylcyclotrisiloxane, tetramethylcyclotetrasiloxane, octamethylcyclotetrasiloxane, heptamethylcyclotetrasiloxane, tetramethyltetravinylcyclotetrasiloxane, tetramethyltetraphenylcyclotetrasiloxane, octaphenylcyclotetrasiloxane, or tetrakis(trifluoropropyl)tetramethylcyclotetrasiloxane. Among them, trimethylcyclotrisiloxane, trimethyltrivinylcyclotrisiloxane, tetramethylcyclotetrasiloxane, or tetramethyltetravinylcyclotetrasiloxane are preferable.

Specific examples of the cyclotrisiloxane or cyclotetrasiloxane to be reacted with the generated metal silanolate include trimethylcyclotrisiloxane, hexamethylcyclotrisiloxane, pentamethylvinylcyclotrisiloxane, hexaethylcyclotrisiloxane, trimethyltrivinylcyclotrisiloxane, trimethyltriphenylcyclotrisiloxane, hexaphenylcyclotrisiloxane, tris(trifluoropropyl)trimethylcyclotrisiloxane, tetramethylcyclotetrasiloxane, heptamethylcyclotetrasiloxane, octamethylcyclotetrasiloxane, tetramethyltetravinylcyclotetrasiloxane, tetramethyltetraphenylcyclotetrasiloxane, octaphenylcyclotetrasiloxane, or tetrakis(trifluoropropyl)tetramethylcyclotetrasiloxane. Among them, trimethylcyclotrisiloxane, hexamethylcyclotrisiloxane, trimethyltriphenylcyclotrisiloxane, hexaphenylcyclotrisiloxane, tris(trifluoropropyl)trimethylcyclotrisiloxane, tetramethylcyclotetrasiloxane, octamethylcyclotetrasiloxane, tetramethyltetraphenylcyclotetrasiloxane, octaphenylcyclotetrasiloxane, or tetrakis(trifluoropropyl)tetramethylcyclotetrasiloxane are preferable, and hexamethylcyclotrisiloxane or octamethylcyclotetrasiloxane are particularly preferable.

In the compound represented by formula (2), M is not particularly limited if it is a monovalent metal. Specific examples include lithium or sodium, and among them, lithium is preferable.

In the case of using acid in order to stop polymerization by adding water or acid to the compound represented by formula (2) as needed, the acid used is not particularly limited if it is a Brønsted acid or an aqueous solution thereof. Specific types of the acid include formic acid, acetic acid, nitric acid, sulfuric acid, or hydrochloric acid, and among them, acetic acid is preferable.

Specific examples of the compound represented by formula (3) include, in the case where X is halogen: allyltrichlorosilane, chloropropyltrichlorosilane, trichloroethylsilane, trichlorooctadecylsilane, trichlorooctylsilane, trichlorochloromethylsilane, trichlorocyanoethylsilane, trichlorocyanopropylsilane, trichlorocyclohexylsilane, trichlorosilane, trichlorodecylsilane, trichlorododecylsilane, trichlorotridecafluorooctylsilane, trichlorotrifluoropropylsilane, trichlorotolylsilane, trichlorovinylsilane, trichlorophenylethylsilane, trichlorophenylsilane, trichlorophenylpropylsilane, trichlorophenylhexylsilane, trichloropropylsilane, trichlorohexylsilane, trichloropentafluorophenylpropylsilane, trichloromethylsilane, butyltrichlorosilane, bromoundecyltrichlorosilane, bromopropyltrichlorosilane, 3-(2-bromo-2-methylpropanoyloxy)propylchlorosilane, 3-(meth)acryloyloxypropyl trichlorosilane, or tetrachlorosilane.

Among them, trichlorosilane, trichloromethylsilane, trichlorophenylsilane or tetrachlorosilane is preferable, and trichlorosilane, trichloromethylsilane, or tetrachlorosilane is more preferable.

Specific examples of the compound represented by formula (3) include, in the case where X is alkoxy: 3-[2-(2-aminoethylamino)ethylamino]propyltrimethoxysilane, 3-(2-aminoethylamino)propyltrimethoxysilane, aminopropyltrimethoxysilane, allyltrimethoxysilane, ureidopropyltrimethoxysilane, epoxycyclohexylethyltrimethoxysilane, chloropropyltrimethoxysilane, glycidoxypropyltrimethoxysilane, N,N-diethylaminopropyltrimethoxysilane, N,N-dimethylaminopropyltrimethoxysilane, trifluoropropyltrimethoxysilane, trimethoxyoctadecylsilane, trimethoxyoctylsilane, trimethoxyvinylsilane, trimethoxyphenylethylsilane, trimethoxyphenylsilane, trimethoxymethylaminopropylsilane, trimethoxymethylsilane, N-phenylaminopropyltrimethoxysilane, butyltrimethoxysilane, bromopropyltrimethoxysilane, hexadecyltrimethoxysilane, (meth)acryloyloxypropyltrimethoxysilane, mercaptopropyltrimethoxysilane, iodopropyltrimethoxysilane, aminopropyltriethoxysilane, isocyanatopropyltriethoxysilane, chloropropyltriethoxysilane, chlorophenyltriethoxysilane, cyanoethyltriethoxysilane, cyanopropyltriethoxysilane, dodecyltriethoxysilane, triethoxyethylsilane, triethoxyoctadecylsilane, triethoxyoctylsilane, triethoxyglycidoxypropylsilane, triethoxysilane, triethoxythienylsilane, triethoxyvinylsilane, triethoxyphenylsilane, triethoxymethylsilane, triethoxymercaptopropylsilane, tridecafluorooctyltriethoxysilane, butyltriethoxysilane, tetramethoxysilane, tetraethoxysilane, tetrapropoxysilane, or tetrabutoxysilane.

Among them, trimethoxysilane, trimethoxymethylsilane, trimethoxyphenylsilane, triethoxysilane, triethoxymethylsilane, triethoxyphenylsilane, tetramethoxysilane, or tetraethoxysilane is preferable, and trimethoxysilane, trimethoxymethylsilane, triethoxysilane, triethoxymethylsilane, tetramethoxysilane, or tetraethoxysilane is more preferable.

In the process of generating the metal silanolate, the reaction temperature is preferably 0 to 50° C., more preferably 20 to 40° C., and the reaction time is preferably 0.1 to 6 hours, more preferably 0.1 to 2 hours. In the process of reacting with cyclic siloxane, the reaction temperature is preferably 0 to 20° C., and the reaction time is preferably 1 to 6 hours. In the case of stopping polymerization by adding water or acid to the compound represented by formula (2) as needed, the reaction temperature during stirring and reacting with water or acid is preferably 0 to 30° C., and the reaction time is preferably 0.1 to 20 hours. In the process of reacting the generated compound represented by formula (1) with the compound represented by formula (2), the reaction temperature is preferably 0 to 20° C., more preferably 0 to 10° C., and the reaction time is preferably 0.1 to 20 hours.

### EXAMPLES

The disclosure will be described further in detail below by synthesis examples and examples in which the organopolysiloxane compound of the disclosure is separately synthesized. However, the disclosure is not limited in any way by these examples.

### <Measurement of Molecular Weight>

The molecular weight of the organopolysiloxane compound was measured by a gel permeation chromatography (GPC) method, and a ratio of weight average molecular weight (Mw) to number average molecular weight (Mn) was taken as a molecular weight distribution (Mw/Mn). Polystyrene was used as a standard sample, and a polystyrene-equivalent molecular weight was measured.

The polystyrene-equivalent molecular weight measurement by the GPC method was performed under the following measurement conditions:
a) measuring apparatus: HPLC LC-2000Plus series, made by JASCO Corporation
b) column: Shodex KF-804L, made by Resonac Corporation (formerly Showa Denko K.K.) (two columns connected in series)
c) oven temperature: 40° C.
d) eluent: toluene, 0.7 mL/min
e) detector: RI-2031
f) standard sample: TSK standard polystyrene, made by Tosoh Corporation
g) injection volume: 20 μL
h) concentration: 0.025 g/10 mL
i) sample preparation: sample was stirred and dissolved at room temperature using toluene as a solvent.

### <Nuclear Magnetic Resonance Spectroscopy (NMR)>

A 500 MHz NMR measuring device made by JEOL Ltd. was used. Regarding ¹H-NMR and ²⁹Si-NMR, a measurement sample was dissolved in deuterated chloroform (made by FUJIFILM Wako Pure Chemical Corporation) and the measurement was performed at room temperature.

### <Thermogravimetric (TG) Analysis>

A TG measuring device made by Rigaku Corporation was used. A weight reduction from an initial sample weight when the temperature was raised from room temperature to 250° C. at a heating rate of 10° C./min was measured, and a reduction rate was calculated as TG to serve as an indicator of the amount of outgas generated by heating. That is, a higher TG value means a larger amount of outgas, and a lower TG value means a smaller amount of outgas. The TG measurement was performed under the following measurement conditions:
a) measuring apparatus: Thermo plus EVO2 TG-DTA8120/S, made by Rigaku Corporation
b) pan: made of aluminum
c) heating rate: 10° C./min
d) measurement atmosphere: air, 200 mL/min
e) standard sample: Al₂O₃
f) sample amount: 10 mg

### Example 1

### Synthesis of Silanol Compound (2′-1) where n=27

In a 500 mL four-necked flask equipped with a stirrer, thermometer and reflux condenser, 2,4,6-trimethyl-2,4,6-trivinylcyclotrisiloxane (3.9 g) and toluene (35.4 g) were added at room temperature and replaced with nitrogen, and further n-butyllithium (11.8 g; 2.6 mol/L) was added and the mixture was stirred for 1 hour. Hexamethylcyclotrisiloxane (51.8 g) and toluene (65.9 g) were added to the flask, N,N-dimethylformamide (9.1 g) was added at 10° C., and the mixture was reacted for 3.5 hours. Acetic acid (5.5 g) was added at 10° C. to stop the polymerization, and the mixture was further stirred for 1 hour.

Water (150 g) was added to the flask at room temperature, and the mixture was stirred for 15 minutes before being transferred to a separatory funnel and allowed to stand. After it was confirmed that the mixture was separated into two layers, the water layer as the lower layer was extracted from the separatory funnel, and the upper layer was further repeatedly washed 8 times with water (200 g).

An organic layer remaining in the separatory funnel was transferred to a 300 mL eggplant flask, and was heated stepwise to 100° C. under reduced pressure conditions using a vacuum pump to distill volatile substances remaining in the product, thereby obtaining a pale yellow transparent liquid (50.5 g).

The chemical shifts as a result of measurement of ¹H-NMR and ²⁹Si-NMR are shown below.

¹H-NMR: δ (ppm): 6.13 to 5.69 (3H), 2.27 (1H), 1.34 to 1.26 (6H), 0.90 to 0.84 (5H), 0.62 to 0.56 (2H), 0.20 to −0.07 (163H).

²⁹Si-NMR: δ (ppm): −1.92, −8.3, −18.7, −19.0 to −20.5.

From these NMR measurement results, it was confirmed that the obtained compound had, on average, a structure of formula (2′-1).

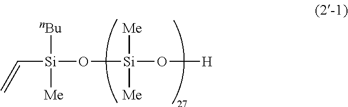

As a result of GPC analysis of the obtained compound, the number average molecular weight (Mn) was 2,400, the weight average molecular weight (Mw) was 2,800, and the molecular weight distribution (Mw/Mn) was 1.16. The values of each average molecular weight are reference values in the structural characterization of formula (2′-1).

### Synthesis and Evaluation of 4-branched Terminal Vinyl Organopolysiloxane Compound (1-1)

In a 100 mL three-necked flask equipped with a stirrer, thermometer and dropping funnel, N,N-dimethylformamide (1.8 g) and toluene (15.8 g) were added at room temperature and replaced with nitrogen, and further tetrachlorosilane (77.0 mg) was added, and the mixture was cooled to 0° C., and stirred for 10 minutes. N,N-dimethylformamide (0.4 g), toluene (4.0 g), the compound (2′-1) (4.0 g) obtained in Example 1, and triethylamine (0.3 g) were prepared in the dropping funnel and added dropwise into the flask over 30 minutes, and the mixture was reacted for 1 hour. 3% aqueous acetic acid solution (20 g) was added at 20° C. to stop the polymerization.

After that, the mixture was transferred to a separatory funnel and allowed to stand. After it was confirmed that the mixture was separated into two layers, the water layer as the lower layer was extracted from the separatory funnel. Further, the upper layer was neutralized with 5% sodium bicarbonate water (20 g) and the lower layer was extracted from the separatory funnel, followed by a washing operation with water (20 g) being repeated 3 times.

An organic layer remaining in the separatory funnel was transferred to a 100 mL eggplant flask, and was heated stepwise to 100° C. under reduced pressure conditions using a vacuum pump to distill volatile substances remaining in the product, thereby obtaining a pale yellow transparent liquid (3.9 g).

The chemical shifts as a result of measurement of ¹H-NMR and ²⁹Si-NMR are shown below.

¹H-NMR: δ (ppm): 6.13 to 5.69 (12H), 1.36 to 1.24 (24H), 0.91 to 0.83 (18H), 0.62 to 0.56 (8H), 0.20 to −0.08 (619H).

²⁹Si-NMR: δ (ppm): −0.78, −16.2 to −19.5, −91.5, −95.9.

From these NMR measurement results, it was confirmed that the obtained compound had, on average, a structure of formula (1-1).

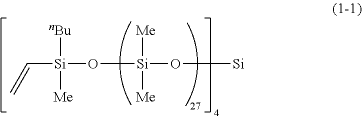

As a result of GPC analysis of the obtained compound, the number average molecular weight (Mn) was 5,800, the weight average molecular weight (Mw) was 6,700, and the molecular weight distribution (Mw/Mn) was 1.17. The values of each average molecular weight are reference values in the structural characterization of formula (1-1).

When the obtained compound was subjected to a TG measurement, the TG was 0.23%.

### Example 2

### Synthesis of Silanol Compound (2′-2) where n=44

In a 1 L four-necked flask equipped with a stirrer, thermometer and reflux condenser, 2,4,6-trimethyl-2,4,6-trivinylcyclotrisiloxane (9.6 g) and toluene (86.8 g) were added at room temperature and replaced with nitrogen, and further n-butyllithium (28.6 g; 2.6 mol/L) was added and the mixture was stirred for 1 hour. Hexamethylcyclotrisiloxane (270.9 g) and toluene (344.4 g) were added to the flask, N,N-dimethylformamide (36.4 g) was added at 10° C., and the mixture was reacted for 3.5 hours. Acetic acid (13.3 g) was added at 10° C. to stop the polymerization, and the mixture was further stirred for 14 hours.

Water (150 g) was added to the flask at room temperature, and the mixture was stirred for 15 minutes before being transferred to a separatory funnel and allowed to stand. After it was confirmed that the mixture was separated into two layers, the water layer as the lower layer was extracted from the separatory funnel, and the upper layer was further repeatedly washed 8 times with water (200 g).

An organic layer remaining in the separatory funnel was transferred to a 500 mL four-necked flask equipped with a stirrer, thermometer, collection flask and distillation head, and was heated stepwise to 100° C. under reduced pressure conditions using a vacuum pump to distill volatile substances remaining in the product, thereby obtaining a pale yellow transparent liquid (248.8 g).

The chemical shifts as a result of measurement of ¹H-NMR and ²⁹Si-NMR are shown below.

¹H-NMR: δ (ppm): 6.11 to 5.69 (3H), 2.22 (1H), 1.33 to 1.26 (6H), 0.87 (4H), 0.58 (2H), 0.19 to −0.07 (264H).

²⁹Si-NMR: δ (ppm): −1.9, −12.7, −19.3, −19.6 to −20.3.

From these NMR measurement results, it was confirmed that the obtained compound had, on average, a structure of formula (2′-2).

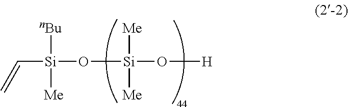

As a result of GPC analysis of the obtained compound, the number average molecular weight (Mn) was 4,100, the weight average molecular weight (Mw) was 4,500, and the molecular weight distribution (Mw/Mn) was 1.10. The values of each average molecular weight are reference values in the structural characterization of formula (2′-2).

### Synthesis and Evaluation of 4-branched Terminal Vinyl Organopolysiloxane Compound (1-2)

In a 100 mL three-necked flask equipped with a stirrer, thermometer and dropping funnel, N,N-dimethylformamide (1.8 g) and toluene (15.8 g) were added at room temperature and replaced with nitrogen, and further tetrachlorosilane (45.0 mg) was added, and the mixture was cooled to 0° C., and stirred for 10 minutes. N,N-dimethylformamide (0.4 g), toluene (4.0 g), the compound (2′-2) (4.0 g) obtained in Example 2, and triethylamine (0.3 g) were prepared in the dropping funnel and added dropwise into the flask over 30 minutes, and the mixture was reacted for 1 hour. 3% aqueous acetic acid solution (20 g) was added at 20° C. to stop the polymerization.

After that, the mixture was transferred to a separatory funnel and allowed to stand. After it was confirmed that the mixture was separated into two layers, the water layer as the lower layer was extracted from the separatory funnel. Further, the upper layer was neutralized with 5% sodium bicarbonate water (20 g) and the lower layer was extracted from the separatory funnel, followed by a washing operation with water (20 g) being repeated 3 times.

An organic layer remaining in the separatory funnel was transferred to a 100 mL eggplant flask, and was heated stepwise to 100° C. under reduced pressure conditions using a vacuum pump to distill volatile substances remaining in the product, thereby obtaining a pale yellow transparent liquid (3.9 g).

The chemical shifts as a result of measurement of ¹H-NMR and ²⁹Si-NMR are shown below.

¹H-NMR: δ (ppm): 6.13 to 5.69 (12H), 1.36 to 1.24 (24H), 0.91 to 0.83 (17H), 0.62 to 0.56 (8H), 0.20 to −0.08 (1034H).

²⁹Si-NMR: δ (ppm): −0.78, −16.2 to −19.5, −91.5, −95.9.

From these NMR measurement results, it was confirmed that the obtained compound had, on average, a structure of formula (1-2).

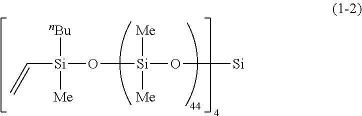

As a result of GPC analysis of the obtained compound, the number average molecular weight (Mn) was 11,200, the weight average molecular weight (Mw) was 13,300, and the molecular weight distribution (Mw/Mn) was 1.19. The values of each average molecular weight are reference values in the structural characterization of formula (1-2).

When the obtained compound was subjected to a TG measurement, the TG was 0.19%.

### Example 3: Synthesis and Evaluation of 3-branched Terminal Vinyl Organopolysiloxane Compound (1-3)

In a 100 mL three-necked flask equipped with a stirrer, thermometer and dropping funnel, N,N-dimethylformamide (1.8 g) and toluene (15.8 g) were added at room temperature and replaced with nitrogen, and further trichloromethylsilane (90.0 mg) was added, and the mixture was cooled to 0° C., and stirred for 10 minutes. N,N-dimethylformamide (0.4 g), toluene (4.0 g), the compound (2′-1) (4.0 g) obtained in Example 1, and triethylamine (0.2 g) were prepared in the dropping funnel and added dropwise into the flask over 30 minutes, and the mixture was reacted for 1 hour. 3% aqueous acetic acid solution (20 g) was added at 20° C. to stop the polymerization.

After that, the mixture was transferred to a separatory funnel and allowed to stand. After it was confirmed that the mixture was separated into two layers, the water layer as the lower layer was extracted from the separatory funnel. Further, the upper layer was neutralized with 5% sodium bicarbonate water (20 g) and the lower layer was extracted from the separatory funnel, followed by a washing operation with water (20 g) being repeated 3 times.

An organic layer remaining in the separatory funnel was transferred to a 100 mL eggplant flask, and was heated stepwise to 100° C. under reduced pressure conditions using a vacuum pump to distill volatile substances remaining in the product, thereby obtaining a pale yellow transparent liquid (3.9 g).

The chemical shifts as a result of measurement of ¹H-NMR and ²⁹Si-NMR are shown below.

¹H-NMR: δ (ppm): 6.13 to 5.69 (9H), 1.39 to 1.22 (19H), 0.92 to 0.82 (16H), 0.64 to 0.48 (7H), 0.25 to −0.10 (548H).

²⁹Si-NMR: δ (ppm): −1.69, −18.3 to −20.5, −53.5.

From these NMR measurement results, it was confirmed that the obtained compound had, on average, a structure of formula (1-3).

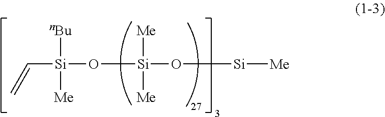

As a result of GPC analysis of the obtained compound, the number average molecular weight (Mn) was 4,800, the weight average molecular weight (Mw) was 5,700, and the molecular weight distribution (Mw/Mn) was 1.21. The values of each average molecular weight are reference values in the structural characterization of formula (1-3).

When the obtained compound was subjected to a TG measurement, the TG was 0.18%.

### Example 4: Synthesis and Evaluation of 3-branched Terminal Vinyl Organopolysiloxane Compound (1-4)

In a 100 mL three-necked flask equipped with a stirrer, thermometer and dropping funnel, N,N-dimethylformamide (1.8 g) and toluene (15.8 g) were added at room temperature and replaced with nitrogen, and further trichloromethylsilane (53.0 mg) was added, and the mixture was cooled to 0° C., and stirred for 10 minutes. N,N-dimethylformamide (0.4 g), toluene (4.0 g), the compound (2′-2) (4.0 g) obtained in Example 2, and triethylamine (0.2 g) were prepared in the dropping funnel and added dropwise into the flask over 30 minutes, and the mixture was reacted for 1 hour. 3% aqueous acetic acid solution (20 g) was added at 20° C. to stop the polymerization.

After that, the mixture was transferred to a separatory funnel and allowed to stand. After it was confirmed that the mixture was separated into two layers, the water layer as the lower layer was extracted from the separatory funnel. Further, the upper layer was neutralized with 5% sodium bicarbonate water (20 g) and the lower layer was extracted from the separatory funnel, followed by a washing operation with water (20 g) being repeated 3 times.

An organic layer remaining in the separatory funnel was transferred to a 100 mL eggplant flask, and was heated stepwise to 100° C. under reduced pressure conditions using a vacuum pump to distill volatile substances remaining in the product, thereby obtaining a pale yellow transparent liquid (3.8 g).

The chemical shifts as a result of measurement of ¹H-NMR and ²⁹Si-NMR are shown below.

¹H-NMR: δ (ppm): 6.13 to 5.69 (9H), 1.39 to 1.22 (18H), 0.92 to 0.82 (16H), 0.64 to 0.48 (7H), 0.25 to −0.10 (779H).

²⁹Si-NMR: δ (ppm): −1.69, −18.3 to −20.5, −53.5.

From these NMR measurement results, it was confirmed that the obtained compound had, on average, a structure of formula (1-4).

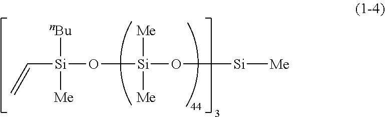

As a result of GPC analysis of the obtained compound, the number average molecular weight (Mn) was 9,300, the weight average molecular weight (Mw) was 11,000, and the molecular weight distribution (Mw/Mn) was 1.18. The values of each average molecular weight are reference values in the structural characterization of formula (1-4).

When the obtained compound was subjected to a TG measurement, the TG was 0.15%.

### Comparative Example 1: Synthesis and Evaluation of 4-branched Terminal Vinyl Organopolysiloxane Compound (1-5)

In the present comparative example, a compound (1-5) was synthesized by a method similar to that described in Japanese Patent No. 5039250.

Specifically, in a 100 mL three-necked flask equipped with a stirrer, thermometer, dropping funnel and reflux condenser, tetrakis[dimethyl(vinyl)silyloxy]silane (2.16 g), octamethylcyclotetrasiloxane (37.0 g), and trifluoromethanesulfonic acid (1.7 g) were added at room temperature and replaced with nitrogen, and the mixture was heated to 90° C., and reacted for 5 hours. After cooling to room temperature, water (5 g) was added and the mixture was stirred for 15 minutes. After that, the mixture was transferred to a separatory funnel and allowed to stand. After it was confirmed that the mixture was separated into two layers, the water layer as the lower layer was extracted from the separatory funnel. Further, the upper layer was neutralized with 5% sodium bicarbonate water (10 g) and the lower layer was extracted from the separatory funnel, followed by a washing operation with water (20 g) being repeated 3 times.

An organic layer remaining in the separatory funnel was transferred to a 500 mL eggplant flask, and was heated stepwise to 100° C. under reduced pressure conditions using a vacuum pump to distill volatile substances remaining in the product, thereby obtaining a pale yellow transparent liquid (37.9 g).

The chemical shifts as a result of measurement of ¹H-NMR and ²⁹Si-NMR are shown below.

¹H-NMR: δ (ppm): 6.13 to 5.70 (12H), 0.28 to −0.08 (553H).

²⁹Si-NMR: δ (ppm): −0.78, −16.2 to −19.5, −91.5, −95.9.

From these NMR measurement results, it was confirmed that the obtained compound had, on average, a structure of formula (1-5).

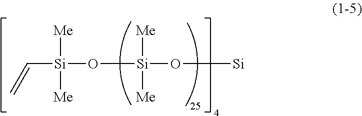

As a result of GPC analysis of the obtained compound, the number average molecular weight (Mn) was 3,700, the weight average molecular weight (Mw) was 8,500, and the molecular weight distribution (Mw/Mn) was 2.30. The values of each average molecular weight are reference values in the structural characterization of formula (1-5).

When the obtained compound was subjected to a TG measurement, the TG was 0.89%.

From Examples 1 to 4 and Comparative Example 1, it was shown that, compared to organopolysiloxane compounds having a molecular weight distribution (Mw/Mn) of greater than 2.0, organopolysiloxane compounds having a molecular weight distribution (Mw/Mn) of 2.0 or less have less weight reduction at 250° C., thus suppressing the generation of outgas due to heating.

The organopolysiloxane compound of the disclosure is a material that can be used as a raw material of silicone rubber compositions in building materials, daily necessities, medical equipment, electronic materials or the like, and is a material that can be used to impart, to organic resins, characteristics such as excellent flexibility, water repellency, releasability, weather resistance, heat resistance, and electrical insulation properties due to the structure of the organopolysiloxane compounds, by being used as a raw material of silicone rubber compositions or as an additive to the organic resins. In particular, by using the organopolysiloxane compound of the disclosure for an electronic material such as semiconductors in which outgas generation is undesirable, it is expected that contact failures, adhesion failures, or heating furnace contamination or the like can be prevented.

What is claimed is:

1. An organopolysiloxane compound, represented by formula (1) and having a molecular weight distribution (Mw/Mn) of 2.0 or less, 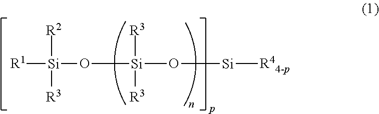
wherein, in formula (1), R¹ is hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, aryl in which at least one hydrogen atom may be replaced with a halogen atom, a functional group, or a group having a functional group;
R² is alkyl or aryl;
R³ is each independently hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, or aryl in which at least one hydrogen atom may be replaced with a halogen atom;
R⁴ is hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, aryl in which at least one hydrogen atom may be replaced with a halogen atom, a functional group, or a group having a functional group;
n is an integer of 3 or greater; and
p is 3 or 4.

2. The organopolysiloxane compound according to claim 1, wherein
in formula (1), R¹ is hydrogen, or alkenyl having 2 to 6 carbon atoms; R² is alkyl having 1 to 4 carbon atoms or phenyl; R³ is each independently hydrogen, methyl, vinyl, 3,3,3-trifluoropropyl, or phenyl.

3. The organopolysiloxane compound according to claim 1, wherein
in formula (1), R¹ is hydrogen or vinyl; R² is alkyl having 1 to 4 carbon atoms or phenyl; R³ is each independently hydrogen, methyl, vinyl, 3,3,3-trifluoropropyl, or phenyl.

4. The organopolysiloxane compound according to claim 1, wherein
in formula (1), R¹ is hydrogen or vinyl; R² is butyl; R³ is methyl; R⁴ is hydrogen or methyl.

5. A production method of the organopolysiloxane compound according to claim 1, comprising processes of:
reacting an organometallic compound with a cyclic siloxane to generate a metal silanolate;
followed by reacting the metal silanolate with cyclotrisiloxane or cyclotetrasiloxane, thereby generating a compound represented by formula (2); and
further followed by reacting the compound represented by formula (2) with a compound represented by formula (3), 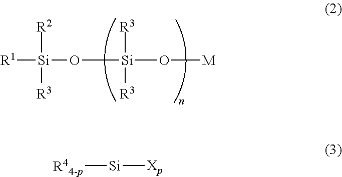
wherein, in formula (2), R¹ is hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, aryl in which at least one hydrogen atom may be replaced with a halogen atom, a functional group, or a group having a functional group;
R² is alkyl or aryl;
R³ is each independently hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, or aryl in which at least one hydrogen atom may be replaced with a halogen atom;
M is a monovalent metal; and
n is an integer of 3 or greater, and
in formula (3), R⁴ is hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, aryl in which at least one hydrogen atom may be replaced with a halogen atom, a functional group, or a group having a functional group;
X is halogen or alkoxy; and
p is 3 or 4.

6. The production method of the organopolysiloxane compound according to claim 5, wherein
the organometallic compound is an alkyllithium compound, the cyclic siloxane is a compound represented by formula (4), and the metal silanolate is a lithium silanolate, 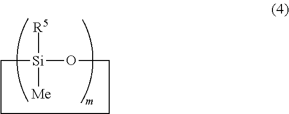
wherein, in formula (4), Me represents methyl;
R⁵ is hydrogen or vinyl; and
m is 3 or 4.

7. A production method of the organopolysiloxane compound according to claim 1, comprising processes of:
reacting an organometallic compound with a cyclic siloxane to generate a metal silanolate;
followed by reacting the metal silanolate with cyclotrisiloxane or cyclotetrasiloxane, thereby generating a compound represented by formula (2);
followed by stopping polymerization by adding water or acid to the compound represented by formula (2), thereby generating a compound represented by formula (2′); and
further followed by reacting the compound represented by formula (2′) with a compound represented by formula (3), 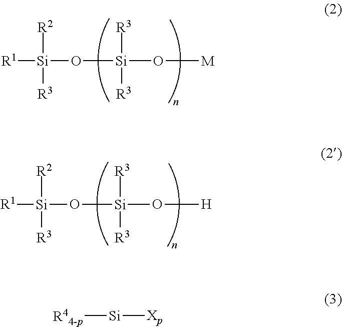
wherein, in formula (2), R¹ is hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, aryl in which at least one hydrogen atom may be replaced with a halogen atom, a functional group, or a group having a functional group;
R² is alkyl or aryl;
R³ is each independently hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, or aryl in which at least one hydrogen atom may be replaced with a halogen atom;
M is a monovalent metal; and
n is an integer of 3 or greater;
in formula (2′), R¹, R², and R³ are groups having the same definitions as R¹, R², and R³ in formula (2); and
n has the same definition as n in formula (2); and
in formula (3), R⁴ is hydrogen, alkyl in which at least one hydrogen atom may be replaced with a halogen atom, alkenyl in which at least one hydrogen atom may be replaced with a halogen atom, alkynyl in which at least one hydrogen atom may be replaced with a halogen atom, cycloalkyl in which at least one hydrogen atom may be replaced with a halogen atom, aryl in which at least one hydrogen atom may be replaced with a halogen atom, a functional group, or a group having a functional group;
X is halogen or alkoxy; and
p is 3 or 4.

8. The production method of the organopolysiloxane compound according to claim 7, wherein
the organometallic compound is an alkyllithium compound, the cyclic siloxane is a compound represented by formula (4), and the metal silanolate is a lithium silanolate, 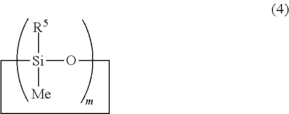
wherein, in formula (4), Me represents methyl;
R⁵ is hydrogen or vinyl; and
m is 3 or 4.
